(19) United States
(12) Patent Application Publication
(10) Pub. No.: US 2017/0355409 A1
(43) Pub. Date: Dec. 14, 2017

(54) PIVOTING BICYCLE SEAT

(71) Applicant: Salvatore Deiana, Vancouver (CA)

(72) Inventor: Salvatore Deiana, Vancouver (CA)

(21) Appl. No.: 15/181,967

(22) Filed: Jun. 14, 2016

(51) Int. Cl. B62J 1/00; B62J 1/04

(52) U.S. Cl. CPC B62J 1/007; B62J 1/04

(57) ABSTRACT

A bicycle seat assembly for reducing frictional and pressure discomfort to the buttocks and urogenital region of a cyclist. The seat assembly provides for rotation of a bicycle seat about a longitudinal axis of a bicycle to accommodate the movement of the cyclist's legs and hips while pedaling. The assembly may also provide for rotation of the seat about a vertical axis to provide additional relief of frictional and pressure discomfort.

### BACKGROUND OF THE INVENTION

The present invention relates to bicycles, and more particularly to bicycle seats. Bicycle riding on a conventional seat is a pain in the seat, causing urogenital friction. This reality has discouraged many people from riding a bike.

Many contraptions for bicycle seats have been tried, yet none seem to offer a solution for relieving rider discomfort. The problem lies in the momentum that is lost when a cyclist tries to throw the weight of their upper body in order to contribute to the effort applied by the cyclist's a leg against the pedal. The forces applied by the cyclist encounters resistance from the body's stationary midsection in not only non-cooperating but also interrupts this momentum continuum intended to reach the limb in question.

As can be seen, there is a need for an improved bicycle seat that moves in synchrony with the upper and lower body as the rider pedals.

### SUMMARY OF THE INVENTION

In one aspect of the of the present invention, a bicycle seat assembly includes: a seat having an upper surface configured to support the buttocks of a cyclist; a horizontal pivot assembly operatively coupled to a bottom surface of the seat for rotation of the seat about a longitudinal centerline of the bicycle; a bracket assembly operatively connected between the horizontal pivot assembly and a post; wherein the post is adapted to connect the bicycle seat assembly to the bicycle. The horizontal pivot assembly may further include a pivot shaft attached at a fore and an aft end thereof to the bracket assembly; a distended portion extending from a bottom portion of the seat having a hole defined therein that extends along a longitudinal centerline of the distended portion; with the pivot shaft received through the hole. In some embodiments, the horizontal pivot assembly includes a bearing disposed to support the pivot shaft for rotational movement within the hole and the bearing may be a roller bearing. One or more stops may be configured to limit a left and a right rotation of the seat around the shaft. A biasing means may also be included to urge the seat to a neutral position.

In other aspects of the invention, the bicycle seat assembly may also be provided with a vertical pivot assembly that is operatively coupled between the seat and the horizontal pivot assembly for rotational movement of the seat about a vertical axis. The vertical pivot assembly may include a pivot pin extending from the bottom surface of the seat; and a pivot plate having an aperture adapted to receive the pivot pin. As with the longitudinal pivot assembly, the vertical pivot assembly may include a pivot stop extending from the bottom surface of the seat; and an arcuate slot formed in the pivot plate adapted to receive the pivot stop. In some embodiments, a seat retainer is coupled to the pivot stop to retain the seat on the pivot plate. The vertical pivot assembly may further include a pivot disk supported in the pivot plate via a bearing, wherein the aperture is defined in the pivot disk. A bias mechanism may be include to urge the seat in a neutral condition about the vertical axis.

### BRIEF DESCRIPTION OF THE DRAWINGS

FIG. 1 is an overhead perspective view of an embodiment of a bicycle seat of the present invention applied to a bicycle seat post.

FIG. 2 is an overhead perspective view of an embodiment of a bicycle seat of the present invention.

FIG. 3 is an exploded view of an embodiment of a bicycle seat of the present invention.

FIG. 4 is a bottom perspective view of a bicycle seat of the present invention.

FIG. 5 is an exploded bottom perspective view of a bicycle seat of the present invention.

FIG. 6 is an exploded perspective view of a pivot shaft and roller of the present invention.

FIG. 7 is an assembled view of a pivot shaft and roller of the present invention.

FIG. 8 is a side perspective view of an alternative embodiment of a bicycle seat of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a bicycle seat that provides for pivotal movement of a bicycle seat to accommodate for the smooth application of pedaling forces by a cyclist.

The seat can be made to move forward and back or side to side. Making a seat that moves forward and back won't solve but create new problems. Why? Because while the upper body leans forward to help the leg that is pressuring the pedal has, at the same time the body has to deal with the other leg that is receding. This contortion is adding too and not solving the problem.

The present invention was made after a lifetime of observation of how cyclists shift their body as they pedal gave me a hint on how to resolve the problem once for all. Pedaling is about shifting the body side to side in a rolling fashion and the seat should likewise mimic this movement and eliminate the friction in the cyclist's groin and seat area.

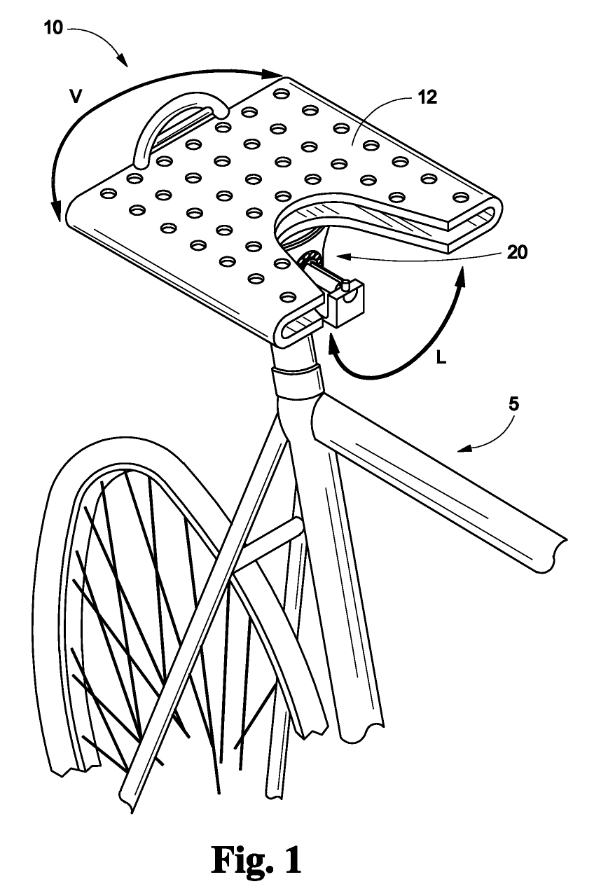

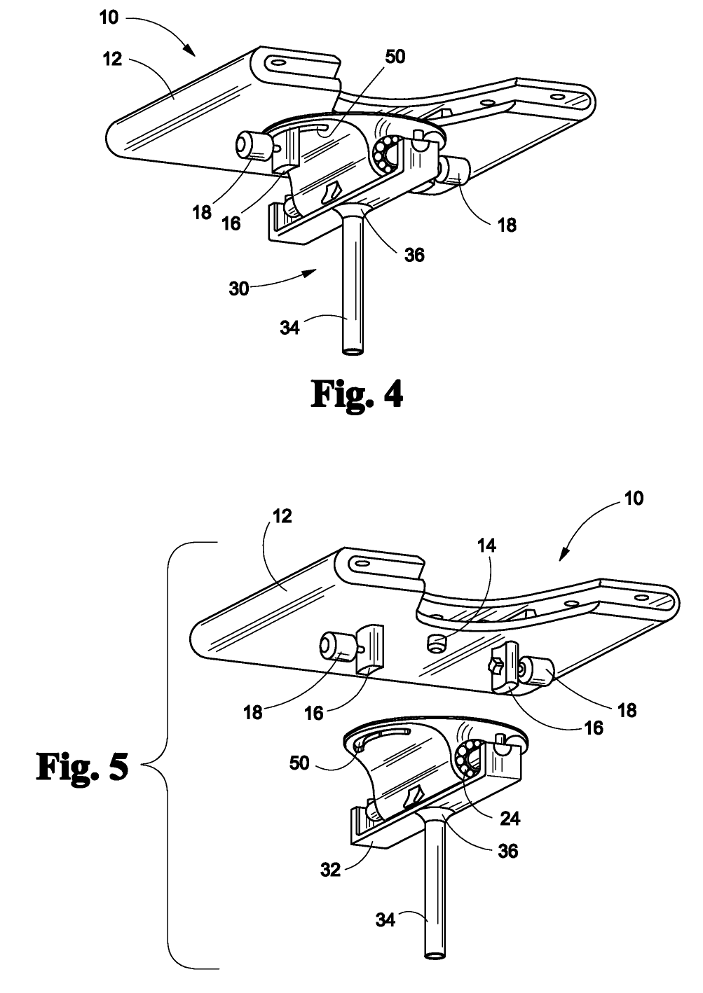

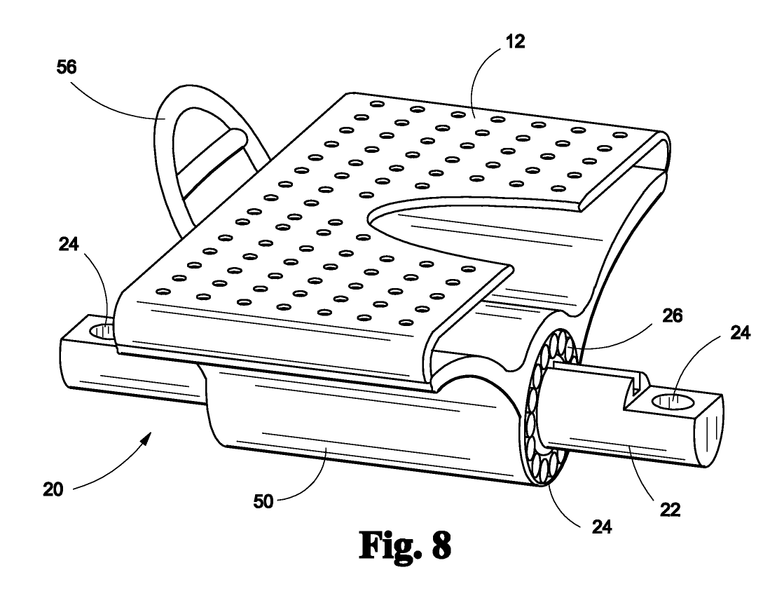

This is what the claimed Side Roller seats do. In one embodiment shown in reference to FIG. 8, a Side Roller seat assembly 10 is made of three primary components: a seat portion 12; a longitudinal pivot assembly 20 that permits rotation of the seat 12 substantially about a longitudinal axis L of the bicycle 5; and a seat mount 30 to operatively attach the seat assembly 10 to a bicycle 5. In a preferred embodiment, shown in reference to FIGS. 1-5, the side roller seat assembly 10 may also include a vertical pivot assembly 40 that permits the seat 12 to pivot about a substantially vertical axis V. Each embodiment of the seat assembly 10 may also include an elastic, elastomeric, or spring bias centering mechanism to return the seat to a neutral position when the rider is not seated upon the assembly.

As shown in reference to FIG. 1, the seat 12 of the preferred embodiment may pivot substantially about the longitudinal axis of the bicycle and the substantially vertical axis of the bicycle. As will be appreciated by those familiar with bicycle seats, the exact alignment of the longitudinal and vertical axes of rotation will vary based upon the bicycle's dimensions and orientation of its components, such as wheel diameter, fork lengths, handle bar height, pedal length and position. The axes of rotation will also be influenced by consideration of the cyclist's anthropomorphic measurements with respect to the bicycle's dimensions.

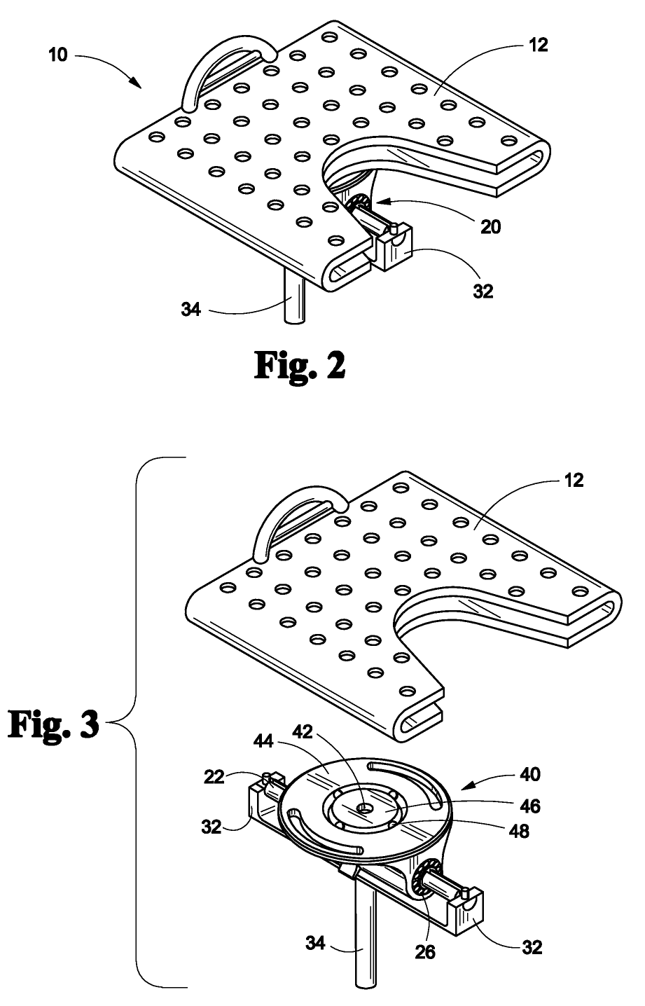

As seen in reference to FIGS. 2 and 5, the preferred embodiment of the seat assembly 10 will have a seat 12 mounted to a vertical pivot assembly 40. The seat 12 has a top surface and a bottom surface. A pivot post 14 is defined in the bottom surface of the seat 12 at a desired pivot point, preferably centered with respect to the lateral aspects of the seat 12 and is positioned along the longitudinal length of the seat 12. The pivot post 14 is adapted to be received in a pivot aperture 42 defined in an upper surface of a pivot plate 44. The pivot aperture 42 may be formed in a pivot disk 46 that is carried in the pivot plate 44 via a bearing 48.

In some embodiments, at least one pivot stop 16 extends from the bottom surface of the seat 12. The pivot stop 16 is adapted to be received in an arcuate slot 50 formed in the top surface of the pivot plate 44. The arcuate slot 50 has a first end and a second end that limits the rotation of the seat 12 when the stop 16 engages the ends. A seat retainer 18 may engage with the stop 16 to retain the seat 12 on the pivot plate 44. The seat retainer 18 may also be selectively positioned so as to lock the seat 12 in a neutral position and prevent rotation about the vertical axis.

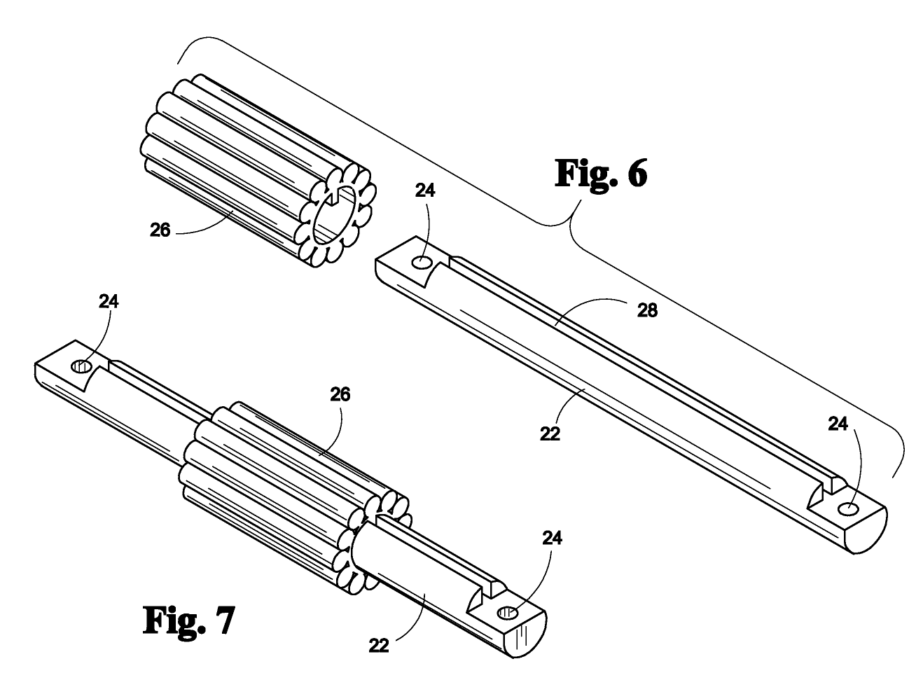

In reference to FIG. 3-7, the longitudinal pivot assembly 20 includes a pivot shaft 22. A forward and an aft end of the pivot shaft 22 is mounted to a pivot bracket 32 operatively coupled to the post assembly 30. The forward end and the aft end of the pivot shaft 22 may have a bore 24 extending through the lateral sides of the shaft 22 to receive a fastener, such as a bolt, screw, rivet, or pin, to attach the shaft to the bracket 32. The shaft 22 is also provided with a bearing 26, which may be a roller bearing, or the like to support rotation of the pivot assembly 40 about the shaft 22. The shaft 22 may also include a longitudinal slot 28 to retain the bearing 26.

A lower portion of the pivot assembly 40 includes a distended portion 50, which may extend along the longitudinal length of the pivot assembly 40 or may define a plurality of lobes or collars to support the pivot assembly 40 on the shaft. The distended portion 50 has a hole extending there through to receive the shaft 22 and the bearing 26. The distended portion 52 may also include a lateral stop 54 positioned to engage with the bracket 32 when reaching a left and a right limit of rotation about the longitudinal centerline of the bicycle 14. The lateral stop 54 may also be formed as a progressively compressible or resilient member to provide for centering of the seat 12 in a neutral position.

In further reference to FIG. 5, the bracket 32 is operatively coupled to a seat post tube 34 of the post assembly 30 via a coupling 36. The coupling 36 may be a weld, or a conventional bicycle seat attachment bracket that permits adjustment for rotational alignment of the seat 12 on the post 34 as well as a fore and aft tilt adjustment of the seat assembly 10. In certain embodiments, the coupling 36 may also permit adjustments for longitudinal positioning of the seat 12 on the post 34.

An alternative embodiment of the seat assembly 10 may be seen in reference to FIG. 8. In this alternative embodiment, the seat assembly 10 does not include the vertical pivot assembly 40. The lower portion of the seat assembly 10 is formed with a distended portion 50 to retain the bearing assembly 48.

The components of the vertical pivot assembly 40 may be formed from any suitable material, such as light weight high strength metals, carbon fiber, or composites. The pivot stops 16 may be formed from similar materials, or may be formed of an elastomeric or resilient material so as to cushion the plate 44 stoppage as the limits of rotation are reached.

The seat 12 may be formed in any desirable shape according to a cyclist's comfort preference. However, because the seat 12 of the present invention is able to pivot to accommodate for the deflection of the cyclist's hips and legs during pedaling, the surface area of the seat 12 may be formed substantially wider than that of a conventional bicycle seat. The seat 12 may be formed with the upper surface and lower surface and a substantially hollow interior. The upper surface may have a plurality of perforations to permit ventilation. The upper surface may also be formed such that it may flex and absorb impacts the rider may encounter along a trail or roadway. Because the seat assembly 10 of the present invention permits greater support to a cyclist's buttocks, the forward end of the seat 12 may be substantially cut away so as to avoid the pressure experienced on the cyclist's urogenital region of conventional bicycle seats. The seat 12 may also be provided with an aft stop rail 56 to support an aft aspect of the cyclist buttocks.

It should be understood, of course, that the foregoing relates to exemplary embodiments of the invention and that modifications may be made without departing from the spirit and scope of the invention as set forth in the following claims.

What is claimed is:

1. A bicycle seat assembly comprising:
a seat having an upper surface configured to support the buttocks of a cyclist;
a horizontal pivot assembly operatively coupled to a bottom surface of the seat for rotation of the seat about a longitudinal centerline of the bicycle;
a bracket assembly operatively connected between the horizontal pivot assembly and a post; wherein the post is adapted to connect the bicycle seat assembly to the bicycle.

2. The bicycle seat assembly of claim 1, wherein the horizontal pivot assembly further comprises:
a pivot shaft attached at a fore and an aft end thereof to the bracket assembly;
a distended portion extending from a bottom portion of the seat having a hole defined therein that extends along a longitudinal centerline of the distended portion;
wherein the pivot shaft is received through the hole.

3. The bicycle seat assembly of claim 2, wherein the horizontal pivot assembly further comprises:
a bearing disposed to support the pivot shaft for rotational movement within the hole.

4. The bicycle seat assembly of claim 3, wherein the bearing is a roller bearing.

5. The bicycle seat assembly of claim 4, wherein the horizontal pivot assembly further comprises:
a stop configured to limit a left and a right rotation of the seat around the shaft.

6. The bicycle seat assembly of claim 5, wherein the horizontal pivot assembly further comprises:
a biasing means to urge the seat to a neutral position.

7. The bicycle seat assembly of claim 1, further comprising:
a vertical pivot assembly operatively coupled between the seat and the horizontal pivot assembly for rotational movement of the seat about a vertical axis.

8. The bicycle seat assembly of claim 7, further comprising:
a pivot pin extending from the bottom surface of the seat;
a pivot plate having an aperture adapted to receive the pivot pin.

9. The bicycle seat assembly of claim 8, further comprising:
a pivot stop extending from the bottom surface of the seat; and
an arcuate slot formed in the pivot plate adapted to receive the pivot stop.

10. The bicycle seat assembly of claim 9, further comprising:
a seat retainer coupled to the pivot stop to retain the seat on the pivot plate.

11. The bicycle seat assembly of claim 8, further comprising:
a pivot disk supported in the pivot plate via a bearing;
wherein the aperture is defined in the pivot disk.

12. The bicycle seat assembly of claim 11, further comprising:
a bias mechanism to urge the seat in a neutral condition about the vertical axis.
